(19) United States
(12) Patent Application Publication
(10) Pub. No.: US 2024/0406328 A1
(43) Pub. Date: Dec. 5, 2024

(54) COMPUTER-READABLE STORAGE MEDIUM AND INFORMATION PROCESSING APPARATUS, AND SYSTEM

(71) Applicant: CANON KABUSHIKI KAISHA, Tokyo (JP)

(72) Inventor: Isao Migishima, Ibaraki (JP)

(21) Appl. No.: 18/677,112

(22) Filed: May 29, 2024

(30) Foreign Application Priority Data
Jun. 5, 2023 (JP) 2023-092680

(51) Int. Cl. H04N 1/00

(52) U.S. Cl. CPC H04N 1/00938; H04N 1/00464; H04N 2201/0094

(57) ABSTRACT

The information processing apparatus that can set up a first image processing apparatus in a system including the first image processing apparatus and a second image processing apparatus. The information processing apparatus performs network setting to connect with the first image processing apparatus, receives, from the first image processing apparatus, connection destination information for displaying a setting screen, obtains, based on an import request for setting values which have been set in a second image processing apparatus, accesses a connection destination indicated by the connection destination information and displays the setting screen on which input of setting items corresponding to the obtained setting values has been made unnecessary, and sets the setting values set via the setting screen to the first image processing apparatus to set up the first image processing apparatus.

### BACKGROUND OF THE INVENTION

### Field of the Invention

The present invention relates to a computer-readable storage medium and an information processing apparatus, and a system.

### Description of the Related Art

When an image forming apparatus is newly installed and a user starts using it, various settings are required so that the image forming apparatus can appropriately operate in the user usage environment of the installation site. Japanese Patent Laid-Open No. 2013-162456 discloses a technique that migrates the job history information of a current machine to a new machine and determines settings thereof when replacing the current machine with the new machine.

The aforementioned prior art cannot handle an item such as a password which is a piece of information required for setting the new machine but not included in the job history information. It is therefore necessary to perform the setting work using a setting menu screen, which may lead to a problem such as reduced convenience for the user or the administrator. Furthermore, displaying already migrated settings on the setting menu screen of the newly installed device together with an item that needs setting may force the user to waste time on finding the item, which may result in reduced usability.

### SUMMARY OF THE INVENTION

Embodiments of the present disclosure eliminate the above-mentioned issues with conventional technology.

A feature of embodiments of the present disclosure is to provide a technique that improves user operability when performing setting of an image processing apparatus to be newly installed by importing the settings of an already-installed image processing apparatus.

According to embodiments of the present disclosure, there is provided a non-transitory computer-readable storage medium storing a program for setting up an image processing apparatus that can communicate with an information processing apparatus, wherein, when installed in and executed by the information processing apparatus, the program configured to cause a processor of the information processing apparatus to: perform network setting to connect a first image processing apparatus to the information processing apparatus via a network; receive, from the first image processing apparatus, connection destination information for displaying a setting screen that allows for performing predetermined setting of the first image processing apparatus connected via the network; obtain, based on an import request for setting values which have been set in a second image processing apparatus, the setting values which have been set in the second image processing apparatus; display the setting screen on which input of setting items corresponding to the obtained setting values has been made unnecessary, when accessing a connection destination indicated by the connection destination information and displaying the setting screen of the first image processing apparatus; and set up the first image processing apparatus by setting, to the first image processing apparatus, the setting values which have been set via the setting screen.

According to embodiments of the present disclosure, there is provided an information processing apparatus that can set up a first image processing apparatus in a system including the first image processing apparatus and a second image processing apparatus that can communicate with the information processing apparatus, the information processing apparatus comprising: one or more controllers including one or more processors and one or more memories, the one or more controllers configured to: perform network setting to connect the first image processing apparatus to the information processing apparatus via a network; receive, from the first image processing apparatus, connection destination information for displaying a setting screen that allows for performing predetermined setting of the first image processing apparatus connected via the network; obtain, based on an import request for setting values which have been set in a second image processing apparatus, the setting values which have been set in the second image processing apparatus; display a setting screen on which input of setting items corresponding to the obtained setting values has been made unnecessary, when accessing a connection destination indicated by the connection destination information and displaying the setting screen of the first image processing apparatus; and set up the first image processing apparatus by setting, to the first image processing apparatus, the setting values which have been set via the setting screen.

Further features of the present disclosure will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the disclosure and, together with the description, serve to explain the principles of the disclosure.

FIG. 1 depicts a view illustrating a configuration example of a system according to an embodiment of the present invention.

FIG. 2 is a block diagram for explaining an example of a hardware configuration of an MFP according to the embodiment.

FIG. 3 is a block diagram for explaining an example of a hardware configuration of an information processing terminal according to the embodiment.

FIG. 4 is an explanatory diagram of an example of a process sequence when performing initial setting of an MFP 101 according to the embodiment using a setup tool installed in an information processing terminal.

FIGS. 5A and 5B are flowcharts for explaining an example of an initial setting process to be performed by the information processing terminal according to the embodiment.

FIGS. 6A and 6B are flowcharts for explaining an example of an initial setting process to be performed by the MFP 101 according to the embodiment.

FIGS. 7A to 7D depict views illustrating examples of setting screens of the setup tool to be displayed on an operation panel of the information processing terminal according to the embodiment.

FIG. 8 depicts a view illustrating an example of an initial setting screen to be displayed on the operation panel by a Web browser of the information processing terminal according to the embodiment.

FIG. 9 depicts a view illustrating an example of a mail-setting-for-scan-setting screen to be displayed on the operation panel of the information processing terminal in step S511 illustrated in FIG. 5B.

FIG. 10 depicts a view illustrating an example of a destination name and a fax telephone number imported to the MFP 101 as takeover data in the embodiment.

FIG. 11 depicts a view illustrating an example of mail server setting values used for ScanToEmail imported to the MFP 101 as takeover data in the embodiment.

FIG. 12 depicts a view illustrating an example of a mail-setting-for-scan-setting screen to be displayed on the operation panel of the information processing terminal according to the embodiment.

FIG. 13 depicts a view illustrating an example of a mail-setting-for-scan-setting confirmation screen to be displayed on the operation panel of the information processing terminal according to the embodiment.

FIG. 14 depicts a view illustrating an example of an IP-address-setting screen for importing setting values to be displayed in step S520.

FIG. 15 is a flowchart for explaining a process to be performed by an MFP 301 according to the embodiment from which settings of the MFP 101 are imported.

FIG. 16 depicts a view illustrating an example of a default-setting-for-scan-setting screen which is a screen on which setting is not performed using imported setting values.

FIG. 17 depicts a view illustrating an example of a default setting confirmation screen which is a screen on which all the default setting values of scan setting have been set as a result of import.

FIG. 18 depicts a view illustrating an example of import data for default scan settings.

FIG. 19 depicts a view illustrating an example of the initial setting screen having a setting value correction button added thereto.

### DESCRIPTION OF THE EMBODIMENTS

Embodiments of the present disclosure will be described hereinafter in detail, with reference to the accompanying drawings. It is to be understood that the following embodiments are not intended to limit the claims of the present disclosure, and that not all of the combinations of the aspects that are described according to the following embodiments are necessarily required with respect to the means to solve the issues according to the present disclosure. Further, in the accompanying drawings, the same or similar configurations are assigned the same reference numerals, and redundant descriptions are omitted.

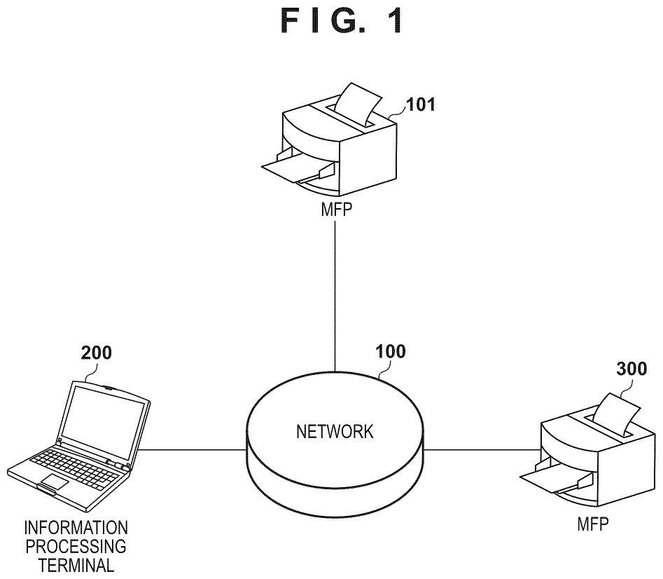

FIG. 1 depicts a view illustrating a configuration example of a system according to an embodiment of the present invention.

The system has an information processing terminal 200, a Multi-Function Peripheral (MFP) 101 and an MFP 301, which are image processing apparatuses that can communicate with the information processing terminal 200 via a network 100. Here, the MFP 101 is a newly installed MFP, and the MFP 301 is an MFP which has been installed before the MFP 101. Here, a process will be described that provides the MFP 101 with the same settings as those of the MFP 301. An application for setting the MFP 101 has been installed in the information processing terminal 200 such as a PC. Here, the network 100 according to the embodiment may be the Internet or a Local Area Network (LAN). In addition, the network 100 may be wired or wireless, or may be connected to the Internet. In addition, the MFP 101, the MFP 301, and the information processing terminal 200 may be connected to each other via a Universal Serial Bus (USB) cable, for example. In such a case, the MFP 101, the MFP 301, and the information processing terminal 200 respectively have a USB communication unit and can communicate with each other by connecting a USB cable to each USB communication unit. In addition, the MFP 101, the MFP 301, and the information processing terminal 200 may be connected via direct wireless communication.

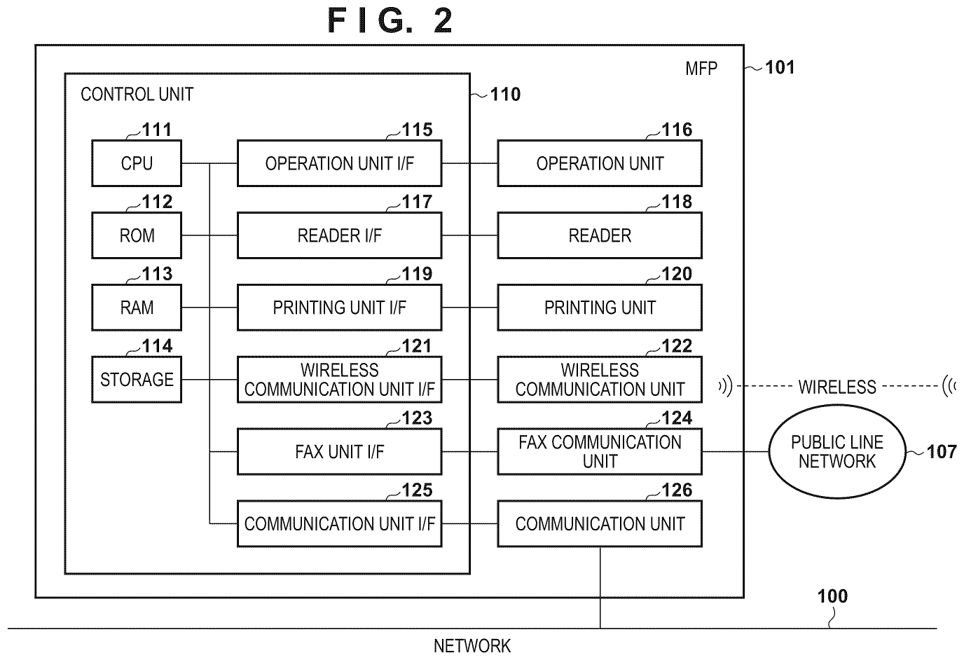

FIG. 2 is a block diagram for explaining an example of a hardware configuration of the MFP 101 according to the embodiment. The MFP 301 has the same hardware configuration as that of the MFP 101, and therefore only the MFP 101 will be described here, omitting description of the hardware configuration of the MFP 301.

The MFP 101 has a CPU 111, a ROM 112, a RAM 113, a storage 114, an operation unit interface (I/F) 115, an operation unit 116, a reader I/F 117, a reader 118, a printing unit I/F 119, and a printing unit 120. Furthermore, the MFP 101 includes a wireless communication unit I/F 121, a wireless communication unit 122, a facsimile unit I/F 123, a facsimile (FAX) communication unit, a FAX communication unit 124, a communication unit I/F 125, and a communication unit 126.

A control unit 110 including the CPU 111 controls overall operation of the MFP 101. The CPU 111 deploys and executes, in the RAM 113, a control program stored in the ROM 112 or the storage 114 to perform various types of control such as read control, print control, or the like. The ROM 112 stores a control program or the like that can be executed by the CPU 111. In addition, the ROM 112 also stores a boot program, font data, or the like. The RAM 113, which functions as a main memory of the CPU 111, is used as a temporary storage area for deploying various control programs stored in the ROM 112 and the storage 114. The storage 114 stores image data, print data, various programs, and various pieces of setting information. Although the embodiment assumes a flash memory to be the storage 114, an auxiliary storage device such as a Solid State Drive (SSD) or a Hard Disk Drive (HDD) may also be used. In addition, an embedded Multi Media Card (eMMC) may also be used.

Here, although the MFP 101 according to the embodiment is assumed to have a single CPU 111 using a single memory (RAM 113) to execute each process illustrated in the flowchart to be described later, the present invention is not limited thereto. For example, each process illustrated in the flowchart to be described later can be executed by a plurality of CPUs, RAMs, ROMs, and storages in cooperation. In addition, a part of the process may be performed using a hardware circuit, such as an Application Specific Integrated Circuit (ASIC) or a Field Programmable Gate Array (FPGA).

The operation unit I/F 115 connects the operation unit 116 including a display unit such as a touch panel, and the control unit 110. The operation unit 116 presents information to the user, or detects an input from the user. The reader I/F 117 connects the reader 118 such as a scanner and the control unit 110. The reader 118 reads an image on a document to obtain image data of the document, and the CPU 111 converts the image data into image data such as binary data. The image data generated based on the image read by the reader 118 may be transmitted to an external apparatus or printed on a recording sheet. The printing unit I/F 119 connects the printing unit 120 such as a printer engine and the control unit 110. When printing an image, the CPU 111 transfers the image data (print data) stored in the RAM 113 to the printing unit 120 via the printing unit I/F 119. The printing unit 120 prints the image based on the transferred image data on a recording sheet which has been fed from a sheet feeding cassette.

The wireless communication unit I/F 121, which is an interface for controlling the wireless communication unit 122, is connected to the control unit 110 and an external wireless device (here, the information processing terminal) via wireless communication. The control unit 110 is connected to a public line network 107 by controlling the FAX communication unit 124 such as a facsimile by the FAX unit I/F 123. The FAX unit I/F 123, which is an interface that controls the FAX communication unit 124, can control a modem for facsimile communication or a Network Control Unit (NCU) to connect to the public line network 107 or control a facsimile communication protocol. The communication unit I/F 125 connects the control unit 110 and the network 100 via the communication unit 126. The communication unit 126 may transmit image data and various types of information of the interior of the apparatus to an external apparatus connected to the network 100, or receive print data from an information processing apparatus connected to the network 100 or information transmitted over the network 100. Transmission and reception over the network 100 may be performed by transmission and reception via e-mail, or file transmission using other protocols (e.g., FTP, SMB, WEBDAV, or the like). Furthermore, image data and various setting data can be transmitted or received via the network 100 by accessing from the information processing terminal 200 using HTTP communication.

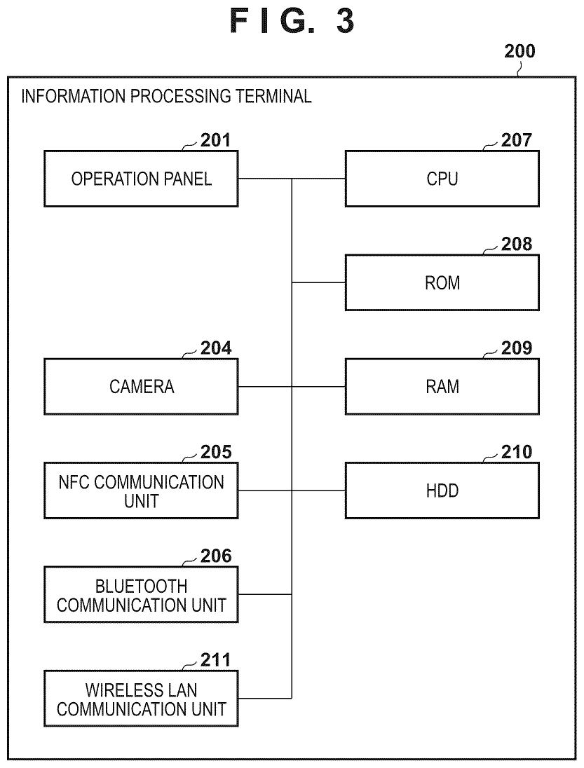

FIG. 3 is a block diagram for explaining an example of a hardware configuration of the information processing terminal 200 according to the embodiment. Although the information processing terminal 200 according to the embodiment is assumed to be a device such as a smartphone, a tablet, or a personal computer, any other device may be used as long as it is an information processing apparatus that can communicate with the MFP 101.

A CPU 207 performs various processes for controlling the operation of the information processing terminal 200 by deploying and executing, in a RAM 209, a control program stored in a ROM 208. The ROM 208 has stored therein control programs or the like. The RAM 209 is used as a main memory for the CPU 207 and a temporary storage area such as a work area. An HDD 210 stores various data such as photographs, electronic documents, or the like. Here, a flash memory, an SSD, or an eMMC, for example, may be employed instead of the HDD 210.

An operation panel 201, which has a touch panel function that can detect a user's touch operation, displays various screens provided by the OS, an e-mail transmission application, or the like. In addition, the operation panel 201 is used for operating a setup tool which is an initial setting application of the MFP 101. The user can input a desired operation instruction to the information processing terminal 200 by inputting a touch operation to the operation panel 201. Here, the information processing terminal 200 includes a hardware key (not illustrated), and the user may input an operation instruction to the information processing terminal 200 using the hardware key.

A camera 204 captures an image in response to an image capture instruction from the user. The image captured by the camera 204 is stored in a predetermined area in the HDD 210. In addition, using a program that can analyze two-dimensional barcodes, it is also possible to obtain information from a two-dimensional barcode read by the camera 204.

The information processing terminal 200 can exchange data with various peripheral devices via a Near Field Communication (NFC) communication unit 205, a Bluetooth (registered trademark) communication unit 206, and a wireless LAN communication unit 211. The Bluetooth communication unit 206 of the information processing terminal 200 may correspond to Bluetooth Low Energy (registered trademark). A setup tool of the MFP 101, which is installed (stored) in a predetermined area of the HDD 210, may be deployed in the RAM 209 and executed.

FIG. 4 is an explanatory diagram of an example of a process sequence when performing initial setting of the MFP 101 according to the embodiment by the setup tool installed in the information processing terminal 200.

First, in S401, the MFP 101 is activated by accepting a power-on instruction from the user. Next, the processing proceeds to S402 and the MFP 101 displays a connection method selection screen on the operation unit 116. The connection method selection screen allows for selecting a connection method between the MFP 101 and the information processing terminal 200, where it is assumed that any connection method may be selected from: USB connection, wired LAN connection, wireless LAN connection (infrastructure connection), and wireless direct connection.

Next, the processing proceeds to S403 and the MFP 101 transitions to a network setting wait state based on the connection method selected in S402. Specifically, the MFP 101 determines whether or not a network setting start command has been received via an interface of the selected connection method. For example, when USB connection is selected on the connection method selection screen, the CPU 111 of the MFP 101 determines whether or not a network setting start command has been received via a USB communication unit (not illustrated) of the MFP 101.

Next, an operation of the information processing terminal 200 will be described.

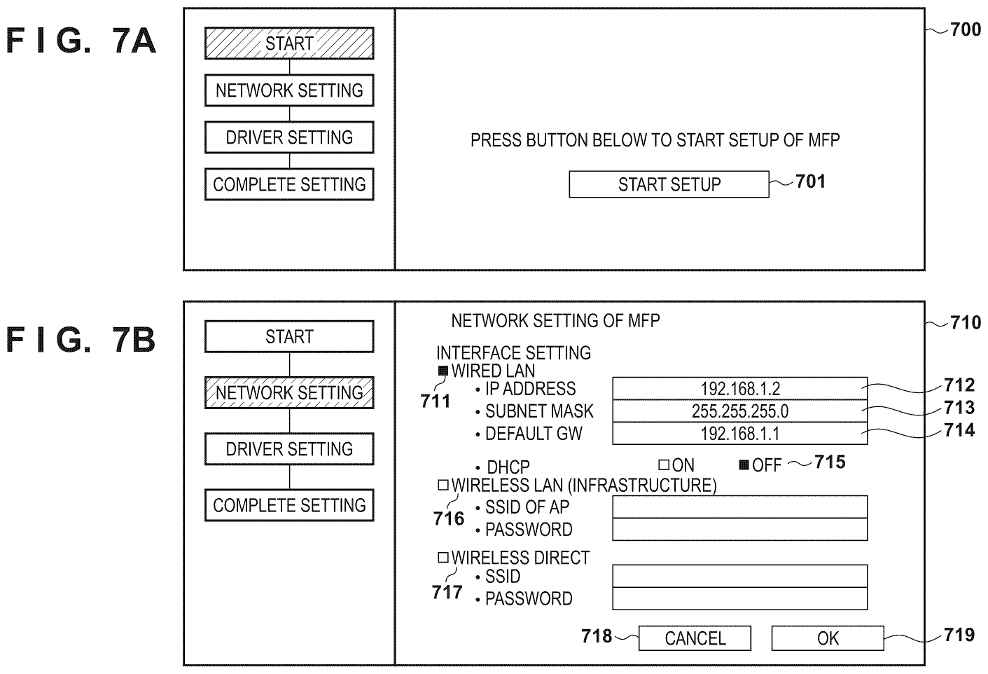

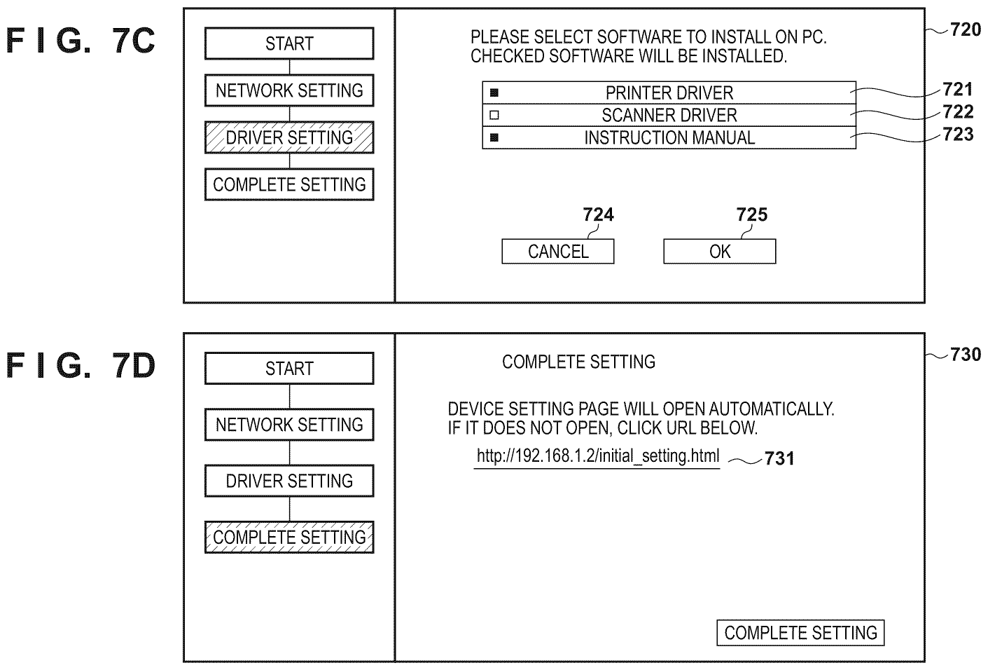

First, in S404, the information processing terminal 200 activates a setup tool, which is an initial setting application of the MFP 101, based on a user operation. The processing then proceeds to S405 to operate the setup tool, and the information processing terminal 200 displays a setup tool screen on the operation panel 201. Upon accepting a network setting start instruction via the setup tool screen, the information processing terminal 200 transmits a network setting execution request to the MFP 101 in S406. Specifically, network setting and software installation are performed based on the settings which have been input via the setting screens 700, 710, 720 and 730 illustrated in FIGS. 7A to 7D.

FIGS. 7A to 7D depict views illustrating examples of setting screens of the setup tool to be displayed on the operation panel 201 of the information processing terminal 200 according to the embodiment. The setting screens 700, 710, 720 and 730 are those displayed on the operation panel 201 upon activation of the setup tool by the CPU 207 of the information processing terminal 200. FIG. 7A depicts a view illustrating an example of a setup tool start screen 700. The setup tool start screen 700 has displayed thereon a setup start button 701 and when the setup start button 701 is selected (pressed), a setup (initial setting) process is started. In the following description, selecting a button or the like includes pressing (touching) a displayed button, Uniform Resource Locator (URL) or the like, or instructing (clicking) with a cursor button or the like.

FIG. 7B depicts a view illustrating an example of a network setting screen 710 of the setup tool. The network setting screen 710 is a screen displayed when the setup start button 701 is selected. The network setting screen 710 allows for setting an interface for the MFP 101. Buttons 711, 716 and 717 on the network setting screen 710 are used for selecting a communication function to be enabled on the MFP 101. In the example illustrated in FIG. 7B, the wired LAN function corresponding to the button 711 is enabled. While the wired LAN function is enabled, the wireless LAN function and the wireless direct function may not be enabled or any desired functions may be simultaneously enabled.

An input field 712 is an area for inputting the IP address of the MFP 101 during wired connection. The input field 713 is an area for inputting a subnet mask of the MFP 101 during wired connection. An input field 714 is an area for inputting a default gateway (GW) of the MFP 101 during wired connection. The setting button 715 is a button for setting whether or not to turn on the Dynamic Host Configuration Protocol (DHCP) function. In FIG. 7B, the DHCP function has been turned off. Setting the DHCP function ON by the setting button 715 disables, and also prohibits correction of, the setting values input to the input fields 712 to 714. When a cancel button 718 is selected, the setup tool cancels the network setting via the setting screen 710. When an OK button 719 is selected, the setup tool stores the setting values input via the setting screen 710 in the HDD 210 of the information processing terminal 200. The setup tool then transmits the setting values input via the setting screen 710 to the MFP 101 as network setting information. On this occasion, the information processing terminal 200 (setup tool) may transmit the setting value via USB communication, or via communication using a wired LAN or a wireless LAN.

FIG. 7C depicts a view illustrating an example of a software setting screen 720 of the setup tool. The software setting screen 720 is displayed when the OK button 719 of the network setting screen 710 is selected, and used for selecting software or the like to be installed in the information processing terminal 200. The software setting screen 720 has buttons 721 to 723 displayed thereon. The button 721 is for installing a printer driver corresponding to the MFP 101. The button 722 is for installing a scanner driver corresponding to the MFP 101. The button 723 is for downloading an instruction manual of the MFP 101. When an OK button 725 is selected in a state where at least one of the buttons 721 to 723 has been selected, software or the like corresponding to the selected button is installed (downloaded) in the information processing terminal 200. When, on the other hand, a cancel button 724 is selected, the software settings on the screen 720 are canceled.

FIG. 7D depicts a view illustrating an example of a setting completion screen 730 of the setup tool. The setting completion screen 730 is displayed when the OK button 725 is selected on the software setting screen 720. A link 731 is displayed on the setting completion screen 730. When the link 731 is selected, a Web browser installed in the information processing terminal 200 is activated and accesses an URL “http: 192.168.1.2/initial_setting.html” corresponding to the link 731. Here, the link 731 may be an object such as a button. In addition, selecting the OK button 725 on the software setting screen 720 may allow for accessing a connection destination information URL even when the user has not selected the link 731. In other words, when the OK button 725 is selected, the setup tool may activate the Web browser installed in the information processing terminal 200 to access the connection destination information URL corresponding to the link 731. A trigger for displaying the setting completion screen 730 or a trigger for causing the Web browser to access a URL may be activated by selecting the OK button 725 or may be activated at a timing at which network setting of the MFP 101 is completed. Completion of network setting of the MFP 101 is determined by reception by the information processing terminal 200 of notification of completion of network setting from the MFP 101.

In the foregoing manner, the setting values which have been set on the network setting screen 710 are transmitted from the information processing terminal 200 to the MFP 101 in S406 in FIG. 4. The MFP 101 thus performs network setting based on the received setting values.

The information processing terminal 200 then instructs, in S407, the MFP 101 to complete the network setting. As a result, the MFP 101 transitions to the normal state instead of the network setting wait state. The MFP 101 then transitions to an initial setting completion waiting state, in S408.

Next, the processing proceeds to S409 and the information processing terminal 200 starts a network connection confirmation process on the MFP 101. The information processing terminal 200 then executes, in S410, the setup tool, transmits a Ping command to the IP address set on the network setting screen 710 in order to confirm network connection to the MFP 101, and confirms whether or not there exists a response. The MFP 101 then transmits, in S411, information indicating “connection OK” to the information processing terminal 200 which has transmitted confirmation of network connection. Here, communication confirmation of the network in S409 may be performed by a protocol such as SNMP. Accordingly, it can be said that the information processing terminal 200 has successfully confirmed network connection to the MFP 101.

Upon confirming network connection to the MFP 101, the information processing terminal 200 makes a request, in S412, to the MFP 101 to obtain the URL of the initial setting page (remote UI). The URL obtained here includes the IP address set by the user on the network setting screen 710. The remote UI of the MFP 101 therefore becomes accessible after initial setting of the network has been completed. Here, the information processing terminal 200 may be configured such that, instead of obtaining the URL from the MFP 101, the setup tool stores the setting values input via the network setting screen 710. In such a case, the setup tool may activate the Web browser to access the stored IP address. As a result, the top page of the remote UI of the MFP 101 may be displayed, from which the screen may automatically jump to the initial setting page.

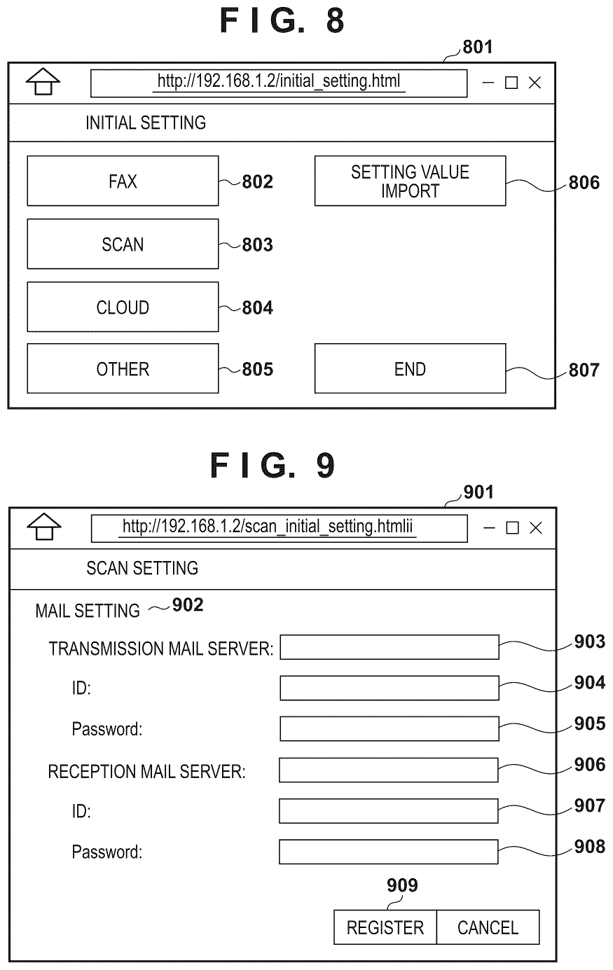

The MFP 101 the generates, in S413, a Web page (remote UI) for initial setting. The Web page includes Hyper Text Markup Language (HTML), Cascading Style Sheets (CSS), Javascript (registered trademark) and image files. The MFP 101 then transmits, in S414, the URL of the generated Web page to the information processing terminal 200 which has transmitted the URL request. The URL transmitted here is a URL for displaying an initial setting screen 801 illustrated in FIG. 8 and described below.

Accordingly, the information processing terminal 200 generates, in S415, the link 731 based on the URL received in S414, and displays the setting completion screen 730 (FIG. 7D) on the operation panel 201 of the information processing terminal 200.

Upon receiving the information processing terminal 200 a selection of the link 731 via the setup tool, the information processing terminal 200 activates the Web browser and accesses the transmitted URL. The information processing terminal 200 then receives various initial settings via the Web browser. Here, the MFP 101, which is intended as a replacement of the MFP 301, performs an import process of setting values in order to take over the setting values of the MFP 301.

Next, an operation of the MFP 301 will be described.

In S416, the MFP 301 is activated by accepting a power-on instruction from the user. The processing then proceeds to S417 to select a connection method similarly to S402, and the MFP 301 subsequently transitions to a standby state.

Upon instructing import of setting values, the information processing terminal 200 issues an import request to the MFP 301 in S418. Upon receiving the import request, the MFP 301 performs an export process of the settings in S419. The MFP 301 then transmits the settings to the information processing terminal 200 in S420. The MFP 301 thus terminates the export process.

Information of the settings transmitted in S420 includes destination names, fax telephone numbers, default scan settings, mail server setting values used for ScanToEmail, or the like. The settings thus accepted are transmitted from the information processing terminal 200 to the MFP 101, and the MFP 101 sets the setting values. Upon the user thus instructing completion of initial setting, a notification indicating completion of setting is transmitted from the information processing terminal 200 to the MFP 101 in S421. The MFP 101 thus transitions, in S422, to the setting completed state, based on the notification transmitted at S421.

As such, the normal activation process which is not the flow of initial setting is performed when power supply to the MFP 101 is turned on next time. In addition, the initial setting completion wait state of the MFP 101 may evolve into the completed state over time without any instruction from the user.

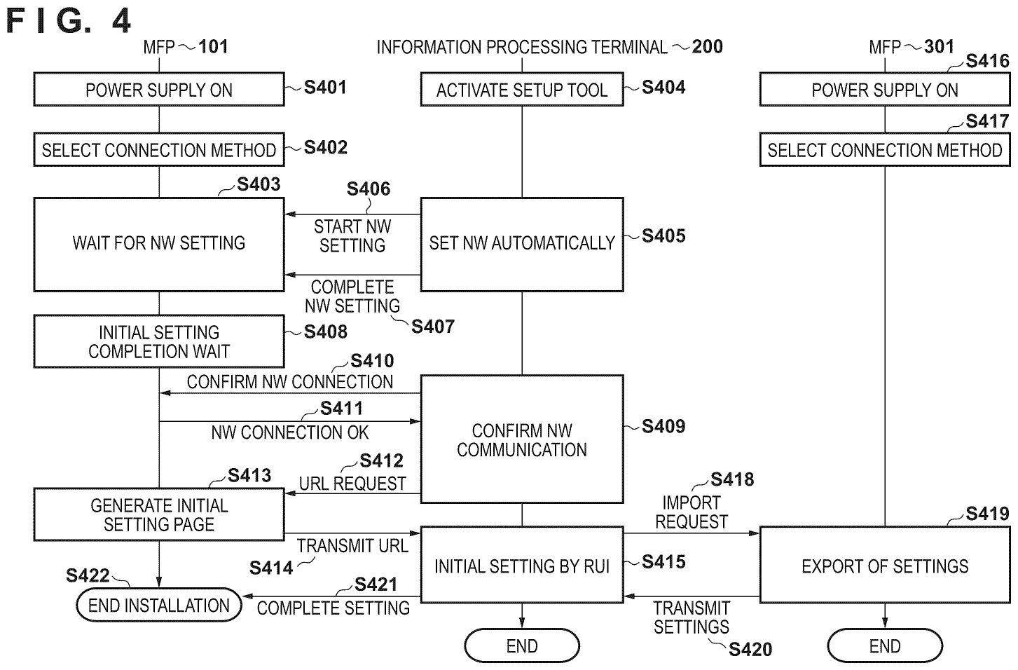

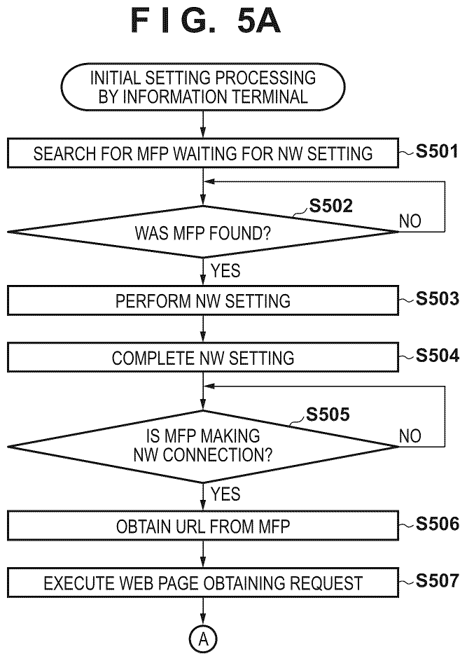

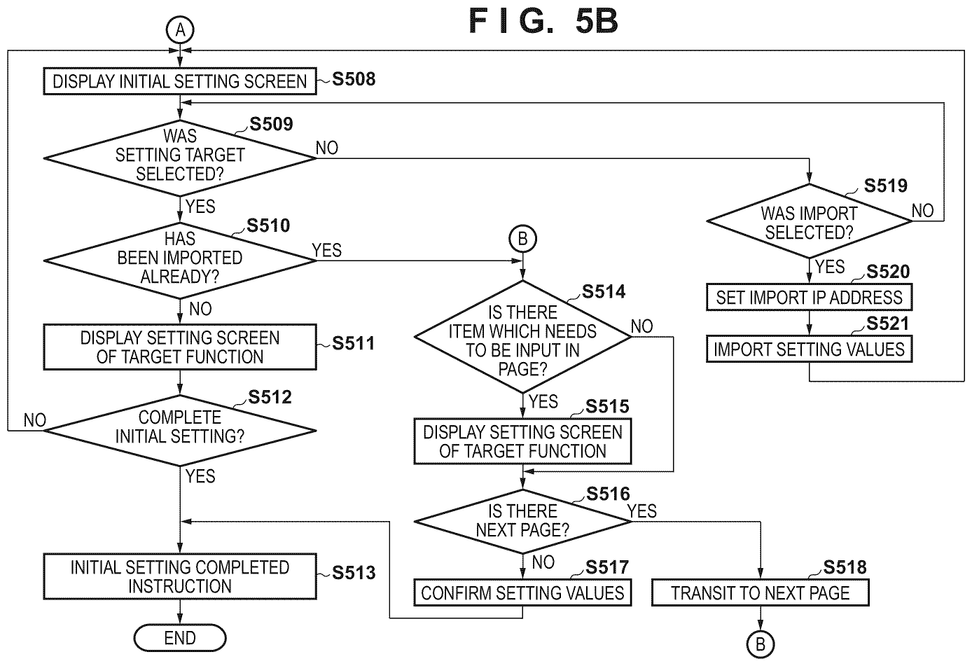

FIGS. 5A and 5B are flowcharts for explaining an example of the initial setting process to be performed by the information processing terminal 200 according to the embodiment. Here, the process illustrated in the flowchart is realized by the CPU 207 that deploys and executes, in the RAM 209, programs such as the setup tool or the Web browser stored in the ROM 208.

In step S501, the CPU 207 operating the setup tool first searches for a device waiting for network setting. On this occasion, the search may be performed via USB communication, or via wired LAN, wireless LAN, or wireless direct communication. The processing then proceeds to step S502 and the CPU 207 determines whether or not the MFP has been found by the search. Upon determining that the MFP has been found, the processing proceeds to step S503, otherwise returns to step S502.

In step S503, the CPU 207 performs network setting. More specifically, when the MFP is found in step S502, the setup tool start screen 700 illustrated in FIG. 7A is displayed on the operation panel 201. Next, selecting the setup start button 701 on the start screen 700 causes the network setting screen 710 illustrated in FIG. 7B to be displayed. The setting screen 710 then accepts input of a communication function (wired LAN, wireless LAN, or wireless direct) to be enabled in the MFP 101, and setting values corresponding to each function. When the OK button 719 is pressed, the CPU 207 transmits the input setting value to the MFP 101. The processing then proceeds to step S504 and the CPU 207 notifies the MFP 101 of completion of network setting (S407 in FIG. 4).

Next, the processing proceeds to step S505 and the CPU 207 confirms network connection for the MFP 101. The foregoing corresponds to the aforementioned step S410 in FIG. 4. When there exists a network response from the MFP 101 in S411, the process proceeds from step S505 to step S506. Otherwise the process keeps waiting in step S505.

In step S506, CPU 207 makes a request to the MFP 101 to obtain a URL, and receives from the MFP 101 the URL for displaying the initially set Web page generated by the MFP 101. The foregoing corresponds to steps S412 and S414 in FIG. 4 described above.

Next, the processing proceeds to step S507 and the CPU 207 makes a request to obtain a Web page for the obtained URL and receives the Web page (HTML file, or the like) from the Web server in the MFP 101. The URL may have assigned thereto a locale name indicating the initial setting screen. Here, the URL which is the transmission destination of the Web page obtaining request may be a URL generated by the setup tool. In such a case, the Web page obtaining request is transmitted to the URL generated based on the IP address input via the network setting screen 710.

The processing then proceeds to step S508 and the CPU 207 activates the Web browser. The Web browser displays a Web page obtained from the MFP 101 on the operation panel 201. Specifically, the initial setting screen 801 illustrated in FIG. 8 is displayed on the Web browser.

FIG. 8 depicts a view illustrating an example of the initial setting screen 801 to be displayed on the operation panel 201 by the Web browser of the information processing terminal 200 according to the embodiment.

The initial setting screen 801 has displayed thereon a FAX button 802, a scan button 803, a cloud button 804, a miscellaneous button 805, a setting value import button 806, and an end button 807.

The processing next proceeds to step S509 and the CPU 207 operating the Web browser accepts, from the user, a selection of a function that needs initial setting, and the processing proceeds to step S510 when the function that needs initial setting is selected (via one of the buttons 802 to 805) by the user, otherwise proceeds to step S519. In step S519, the CPU 207 determines whether or not the setting value import button 806 has been pressed in order to read the setting information of the replacement device and, when the setting value import button 806 has been pressed, the processing proceeds to step S520, otherwise returns to step S509 and keeps waiting for input. In step S520, the CPU 207 displays a screen for setting an IP address for importing setting values on the operation panel 201, and the processing proceeds to step S508.

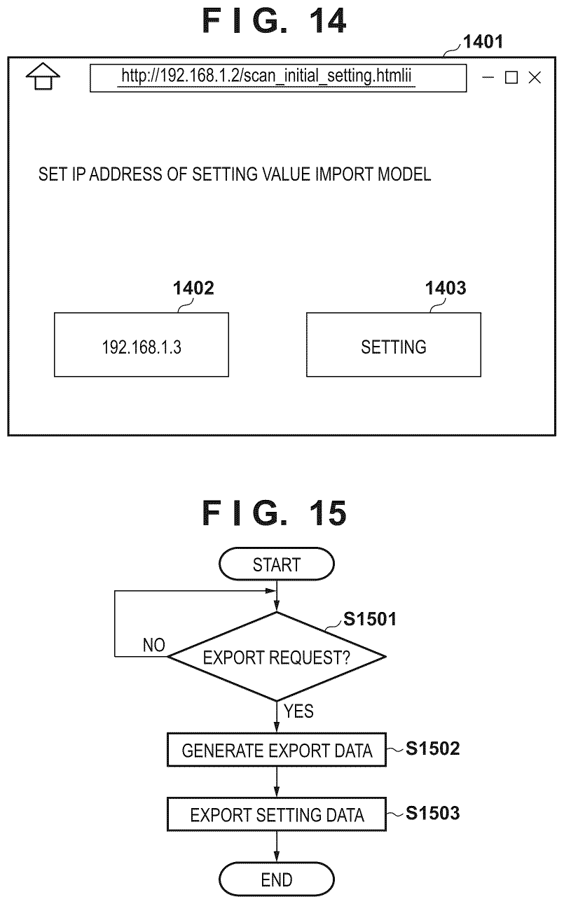

FIG. 14 depicts a view illustrating an example of an IP-address-setting screen 1401 for importing setting values displayed in step S520.

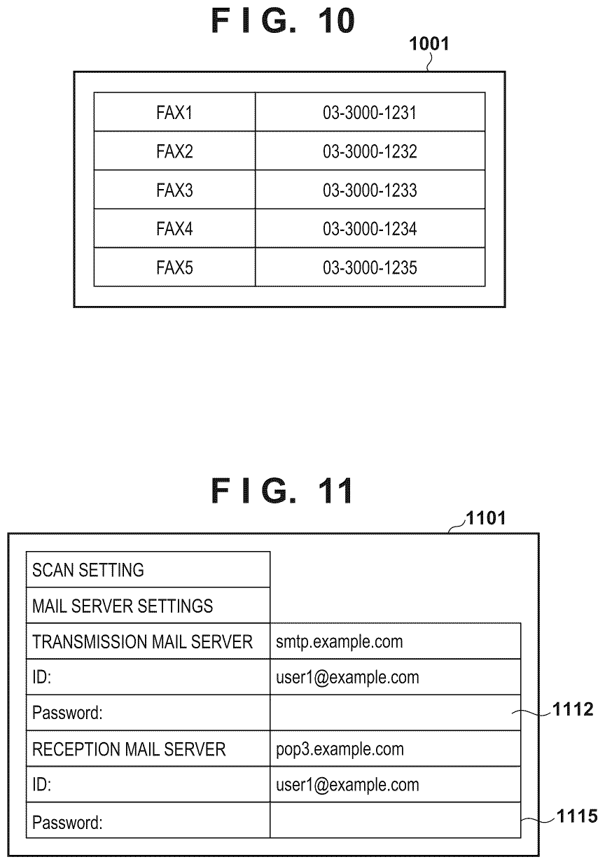

When an IP address is input to an IP address input field 1402 on the IP-address-for-import-setting screen 1401 and a setting button 1403 is pressed, the processing proceeds to step S521. In step S521, the CPU 207 imports setting values using the IP address set via the setting screen 1401 in step S520. Here, the setting value data imported is, for example, settings 1001 of destination names and FAX telephone numbers illustrated in FIG. 10, default scan settings 1801 illustrated in FIG. 18, mail server settings 1101 used for ScanToEmail illustrated in FIG. 11, or the like. After completion of import, the processing proceeds to step S508 and the setting screen is displayed again.

FIG. 10 depicts a view illustrating an example of initial setting information of a FAX function, which includes FAX telephone numbers corresponding to respective destinations (FAX1 to FAX5).

FIG. 11 depicts a view illustrating an example of the initial setting information of a scan function, which includes information of a transmission mail server and a reception mail server used for ScanToEmail.

FIG. 18 depicts a view illustrating an example of the default setting information of the scan function, which includes information such as read size, file format, density, document orientation, type, and sharpness, which will be used in the scan function.

When a function that needs initial setting is selected in step S509, the processing proceeds to step S510 and the CPU 207 operating the setup tool determines whether or not the setting value selected in step S509 has been already imported. Upon determining that the setting value has not been imported, the processing proceeds to step S511, otherwise proceeds to step S514. In step S511, CPU 207 displays an initial setting screen of the function selected by the user in step S509.

Here, in a case that the FAX button 802 has been selected on the initial setting screen 801 illustrated in FIG. 8, for example, a FAX setting screen (not illustrated) is displayed, or in a case that the scan button 803 has been selected, a mail-setting-for-scan-setting screen 901 illustrated in FIG. 9 is displayed on the operation panel 201. In addition, if the cloud button 804 is selected on the initial setting screen 801, a cloud setting screen (not illustrated) is displayed. In addition, if the miscellaneous 805 is selected, a setting screen related to miscellaneous functions of the MFP 101 is displayed.

FIG. 9 depicts a view illustrating an example of a mail-setting-for-scan-setting screen 901 to be displayed on the operation panel 201 of the information processing terminal 200 in step S511 illustrated in FIG. 5B. FIG. 9 illustrates a setting screen example of yet-to-be-imported setting items 902 related to a mail function.

The scan-setting screen 901 has displayed thereon an input field 903 for inputting a host name of a mail transmission server (SMTP server), an input field 904 for an ID used for authentication on the server, and an input field 905 for a password. Furthermore, there are displayed an input field 906 for inputting a host name of a reception mail server (POP server), an input field 907 for an ID used for authentication on the server, and an input field 908 for a password. As such, the mail-setting-for-scan-setting screen 901 allows for setting transmission functions (mail transmission, FTP transmission, and SMB transmission) of the communication unit 126 for transmitting image data generated by scanning a document by the reader 118 of the MFP 101, and a scan function. Subsequently, when a registration button 909 is selected, the setting values input via the mail-setting-for-scan-setting screen 901 are transmitted from the information processing terminal 200 to the MFP 101 via HTTP communication, and the process proceeds to step S512. When a cancel button 910 is selected, the setting on this screen 901 is canceled, and the process proceeds to step S508.

In step S512, the CPU 207 operating the Web browser presents to the user an option to either transition to the initial setting top screen or terminate initial setting. When the end of initial setting is selected, the processing proceeds to step S513, otherwise returns to step S508. The screen transition is performed via communication of the Web browser of the information processing terminal 200 with the Web server of the MFP 101. In step S513, the CPU 207 operating the Web browser sends an instruction to terminate initial setting to the MFP 101.

When the selected function has been imported in step S510, the processing proceeds to step S514 and the CPU 207 operating the setup tool determines whether or not there exists an item that needs to be input when displaying the setting screen to be displayed on the Web browser. When all the items of the function to be imported have already been set in step S514, the process skips step S515 and proceeds to step S516. When, on the other hand, there exists an item that needs to be input in step S514, the processing proceeds to step S515 and the CPU 207 displays a screen for setting the item of the target function.

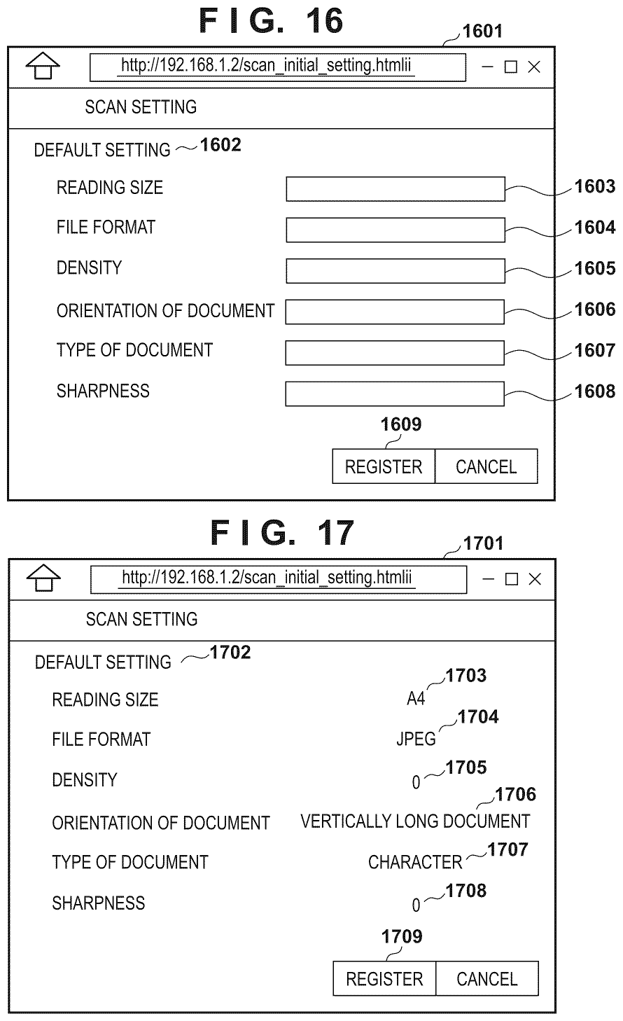

FIG. 16 depicts a view illustrating an example of a default-setting-for-scan-setting screen 1601 which is a screen on which setting is not performed using imported setting values.

In FIG. 16, setting value input fields indicated by reference numerals 1603 to 1608 are displayed as default settings 1602 for scan setting. On the screen 1601, the user can set respective setting values, which are the default settings 1602 for scan setting, by inputting respective setting values and selecting a registration button 1609.

FIG. 17 depicts a view illustrating an example of a default setting confirmation screen 1701 which is a screen on which all the default setting values of scan setting have been set as a result of import.

In FIG. 17, respective setting values are displayed as indicated by reference numerals 1703 to 1708 as default settings 1702 of the scan setting.

In the default setting confirmation screen 1701 of the scan setting, all settings requiring to be set have been set thereon and therefore the display process in step S515 is skipped and the process proceeds to step S516. Selecting a registration button 1709 on the default setting confirmation screen 1701 in FIG. 17 causes the setting values to be registered as the default setting values of scan setting.

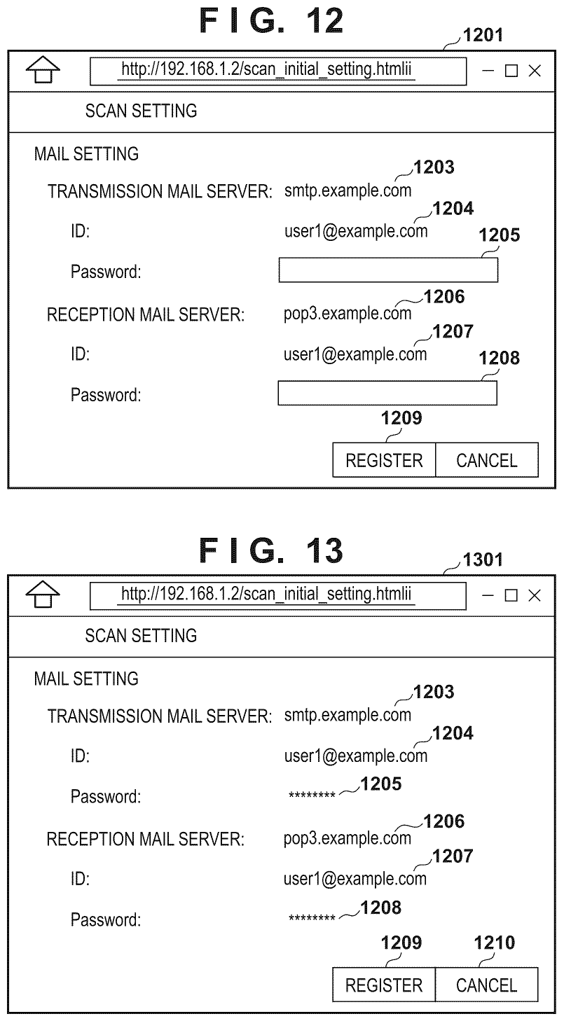

FIG. 12 depicts a view illustrating an example of a mail-setting-for-scan-setting screen 1201 to be displayed on the operation panel 201 of the information processing terminal 200 according to the embodiment.

In the example illustrated in FIG. 12, a transmission mail server setting 1203, an ID 1204, a reception mail server setting 1206, and an ID 1207 have already been set, as a result of import. Password input fields 1205 and 1208 have not been set. When there exists a yet-to-be-input item such as the input fields 1205 and 1208, the process proceeds from step S514 to step S515. In step S515, CPU 207 displays a setting screen of the target function. As such, FIG. 12 illustrates an example of a setting screen including settings already provided by the import of settings. These pairs of the setting 1203 and ID 1204 and the setting 1206 and ID 1207 have already been imported as setting values, respectively, and therefore the setting values are displayed. They are prohibited from being changed on the setting screen 1201 to prevent erroneous change. Accordingly, only the input fields 1205 and 1208 that have not been set by the import process are displayed as blank, with input to the fields being allowed. When required items are input and a registration button 1209 is selected, the process proceeds to step S516. In step S516, the CPU 207 operating the setup tool determines whether or not a next setting screen exists and, upon determining that a next page exists, the processing proceeds to step S518. In step S518, the CPU 207 operating the setup tool transmits the setting provided on the setting screen to the MFP 101 via HTTP communication, performs a transition process onto the next page, and the processing proceeds to step S514. When, on the other hand, it is determined that there is no next page, the process proceeds to step S517. In step S517, the CPU 207 operating the setup tool performs confirmation of the setting values. The screen to be displayed here is, for example, the aforementioned default setting confirmation screen 1701 of the scan setting illustrated in FIG. 17, or a mail-setting-for-scan-setting confirmation screen 1301 illustrated in FIG. 13.

FIG. 13 illustrates an example of the mail-setting-for-scan-setting confirmation screen 1301 to be displayed on the operation panel 201 of the information processing terminal 200 according to the embodiment. In FIG. 13, components common to those in FIG. 12 described above are provided with same reference numerals, and descriptions thereof will be omitted.

Although passwords 1205 and 1208 are masked by asterisks (*), their actual values may be exposed to allow the user having set the passwords to confirm them. Pressing the registration button 1209 or the cancel button 1210 causes the process to proceed to step S513. Here, when the cancel button 1210 is selected, the settings input via the setting screen 1301 are discarded, and the process proceeds to step S513.

According to the process described in the flowcharts illustrated in FIGS. 5A and 5B as has been explained above, various setting values imported from the MFP 301 can be set to the MFP 101. When a function that needs setting whose setting values have already been imported is selected on the initial setting menu screen, the screen for inputting the setting values of the function may not be displayed provided that all the setting values of the function have already been imported and no further input is required. When, on the other hand, there exists a yet-to-be-set item of the function, the screen for inputting a setting value of the item is displayed. On this occasion, displaying the input field of the yet-to-be-set item as a blank field allows for easily identifying a setting value field that needs to be filled.

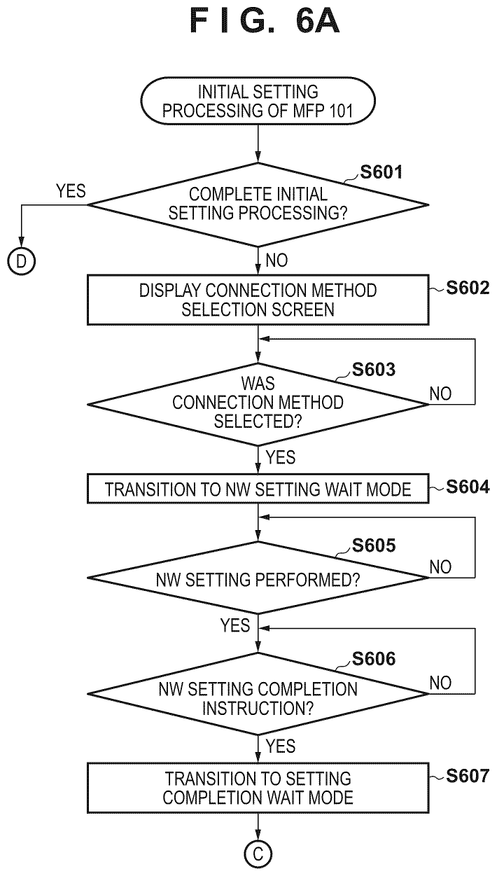

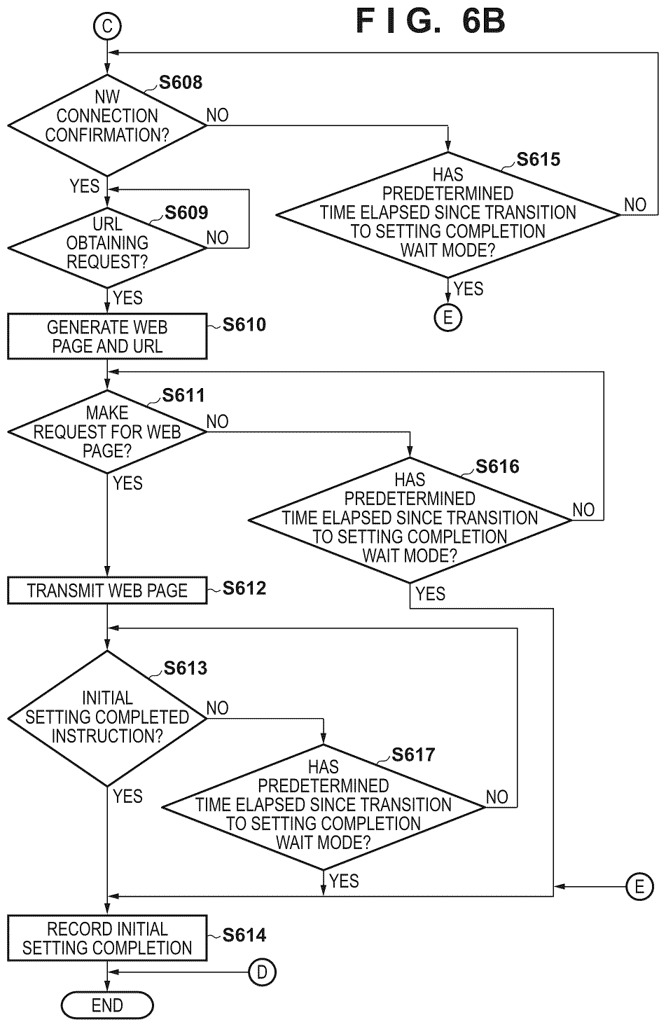

FIGS. 6A and 6B are flowcharts for explaining an example of the initial setting process performed by the MFP 101 according to the embodiment. The process described in the flowchart is realized by the CPU 111 of the MFP 101 that deploys and executes, in the RAM 113, a program stored in the ROM 112.

First, in step S601, the CPU 111 confirms the information stored in the storage 114 and indicating whether or not the initial setting process has been completed. In a case that the initial setting process has not been completed, the process proceeds to step S602, otherwise the process is terminated.

In step S602, CPU 111 displays a selection screen on the operation unit 116 to allow the user to select a connection method and proceeds to step S603, at which the CPU 111 determines whether or not a connection method has been selected via the screen. Upon determining that a connection method has been selected, the processing proceeds to step S604, otherwise returns to step S603 and the CPU 111 waits for selection of a connection method. The foregoing corresponds to S402 in FIG. 4.

In step S604, the CPU 111 transitions to the network setting wait mode. The foregoing corresponds to S403 in FIG. 4. The processing then proceeds to step S605 and the CPU 111 determines whether or not a network setting has been accepted and performed. Upon determining that a network setting has been performed, the processing proceeds to step S606, otherwise returns to step S605 and the CPU 111 waits for reception of a network setting. In step S605, the CPU 111 receives the setting values provided via the network setting screen 710 from the information processing terminal 200. When the network setting has been accepted in step S605, the processing proceeds to step S606, otherwise waits in step S605.

In step S606, the CPU 111 waits for a notification of completion of the network setting and, upon receiving the notification of completion of the network setting, proceeds to step S607, otherwise the processing waits in step S606. In step S607, the CPU 111 transitions to a setting completion wait mode. The CPU 111 thus waits, in step S608, for confirmation of network connection and, upon confirming the network connection, the processing proceeds to step S609 and waits for acceptance of a URL acquisition request. The foregoing corresponds to waiting for reception of a URL obtaining request in S412 in FIG. 4. Upon receiving the URL obtaining request in step S609, the processing proceeds to step S610, otherwise returns to step S609. In step S610, the CPU 111 generates a Web page based on the URL obtaining request, generates a URL of the generated Web page, transmits the URL to the requester, and the processing proceeds to step S611. The foregoing corresponds to S414 in FIG. 4. Here, the Web page may be preliminarily generated.

When the network connection confirmation fails in step S608, the processing proceeds to step S615 and the CPU 111 determines whether or not a predetermined time has elapsed since the transition to the setting completion wait mode in step S607. Upon determining that the predetermined time has elapsed, the processing proceeds to step S614, otherwise returns to step S608.

In step S611, the CPU 111 determines whether or not an obtaining request for a Web page has been received via the communication unit 126. In other words, the CPU 111 determines whether or not there has been an access to the URL generated in step S610 via HTTP communication. Upon receiving the obtaining request in step S611, the processing proceeds to step S612, otherwise proceeds to step S616. In step S616, the CPU 111 determines whether or not a predetermined time has elapsed since the transition to the setting completion wait mode in step S607. Upon determining that the predetermined time has elapsed, the processing proceeds to step S614, otherwise returns to step S611.

In step S612, the CPU 111 transmits, using the POST method of HTTP, a Web page (HTML file or the like) to the information processing terminal 200 which has transmitted the Web page acquisition request via the communication unit 126. The processing then proceeds to step S613 and the CPU 111 determines whether or not a completion instruction of the initial setting has been accepted via the Web page. Upon determining that the completion instruction has been accepted, the processing proceeds to step S614, otherwise proceeds to step S617. In step S617, the CPU 111 determines whether or not a predetermined time has elapsed since the transition to the setting completion wait mode in step S607. Upon determining that the predetermined time has elapsed, the processing proceeds to step S614, otherwise returns to step S613. In step S614, the CPU 111 stores information indicating that the initial setting has been completed in the storage 114, and terminates the process. Here, the predetermined times of steps S615, S616 and S617 may be the same as, or different from, each other.

The foregoing process thus completes the initial setting of the MFP 101 that provides the same settings as those for the MFP 301.

FIG. 15 is a flowchart for explaining a process to be performed by the MFP 301 according to the embodiment from which the settings of the MFP 101 are imported. The process is performed after the MFP 301 is activated in a similar manner to the MFP 101. The process described in the flowchart is realized by the CPU 111 of the MFP 301 that deploys and executes, in the RAM 113, a program stored in the ROM 112.

First, in step S1501, the CPU 111 of the MFP 301 waits for accepting an export request from the information processing terminal 200 and the processing proceeds to step S1502 upon receiving an export request of setting values. In step S1502, the CPU 111 generates export data for exporting the setting values. The processing then proceeds to step S1503, the CPU 111 transmits the export data (setting values) to the information processing terminal 200, and terminates the setting data export process. The foregoing corresponds to the processing in step S419 in FIG. 4.

The content of the export data transferred by the export process includes, for example, the settings 1001 of the FAX telephone numbers illustrated in FIG. 10, the default scan settings 1801 illustrated in FIG. 18, and the mail server settings 1101 used for ScanToEmail illustrated in FIG. 11. Here, the passwords 1112 and 1115 of the mail server settings 1101 illustrated in FIG. 11 are not included. Here, it is assumed that passwords are not exported as setting data. Therefore, there may be a transfer data format that does not have areas for the passwords 1112 and 1115 based on the fact that they will not be exported.

According to the present embodiment as has been described above, selecting a function whose setting values are desired to be set on the initial setting screen causes the setting screen corresponding to the selected function to be displayed, whereby it becomes possible to quickly input setting items. In addition, in a case that there exists an already imported setting value for the selected function, notifying that input of the item is unnecessary or cannot be changed allows the user to focus on only items that require input. As a result, it becomes possible to avoid the risk of malfunction due to a change of a setting value caused by an erroneous operation.

### Modification of Embodiment

In addition, changing an already set item may be performed via an operation from the operation unit 116 of the MFP 101.

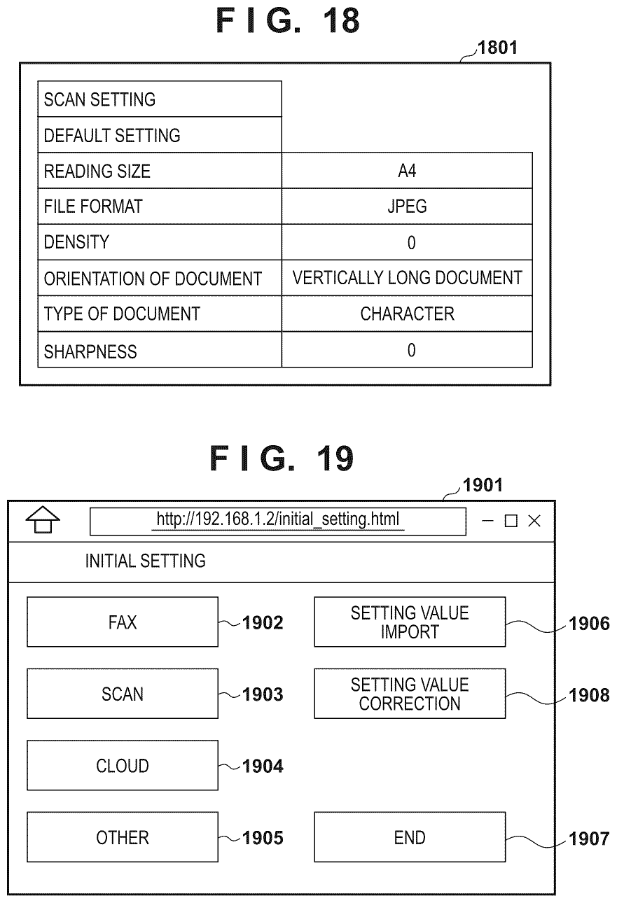

FIG. 19 depicts a view illustrating an example of an initial setting screen 1901 to be displayed on the operation unit 116 of the MFP 101 according to a modification of the embodiment. Here, buttons 1902 to 1906 and 1907 illustrated in FIG. 19 are the same as the buttons 802 to 806 and 807 illustrated in FIG. 8, and therefore description thereof will be omitted.

As illustrated in FIG. 19, adding a setting value correction button (object) 1908 to the initial setting screen 1901 also makes it possible to easily change an already set item. In other words, the operator selects the setting value correction button 1908, and subsequently selects one of the function buttons 1902 to 1905 whose setting value is desired to be changed. Here, selecting the scan button 1903 causes already set default setting values to be displayed in an editable manner, as illustrated in FIG. 17, for example. After having changed necessary items on the screen 1701, the operator then can change the default setting values of the scan function by selecting the registration button 1709.

Although a yet-to-be-imported input field that needs to be filled is displayed as a blank field in the aforementioned embodiment, the present invention is not limited thereto, and when, for example, a certain function has no setting item required to be set, presentation of the setting screen may be skipped. In addition, an item already imported and therefore does not need any setting may be displayed as uneditable. In addition, the final settings may be displayed on the final setting screen that has been input to allow confirmation thereof. In addition, the display may transition to a normal setting display when resetting of an already set item is selected.

### Other Embodiments

Embodiments of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-92680, filed Jun. 5, 2023, which is hereby incorporated by reference herein in their entirety.

What is claimed is:

1. A non-transitory computer-readable storage medium storing a program for setting up an image processing apparatus that can communicate with an information processing apparatus, wherein, when installed in and executed by the information processing apparatus, the program configured to cause a processor of the information processing apparatus to:
perform network setting to connect a first image processing apparatus to the information processing apparatus via a network;
receive, from the first image processing apparatus, connection destination information for displaying a setting screen that allows for performing predetermined setting of the first image processing apparatus connected via the network;
obtain, based on an import request for setting values which have been set in a second image processing apparatus, the setting values which have been set in the second image processing apparatus;
display the setting screen on which input of setting items corresponding to the obtained setting values has been made unnecessary, when accessing a connection destination indicated by the connection destination information and displaying the setting screen of the first image processing apparatus; and
set up the first image processing apparatus by setting, to the first image processing apparatus, the setting values which have been set via the setting screen.

2. The non-transitory computer-readable storage medium according to claim 1, wherein, in the displaying of the setting screen, the program is configured to cause the processor to cause a Web browser installed in the information processing apparatus to access the connection destination indicated by the connection destination information, and
wherein the Web browser displays the setting screen based on data obtained from the connection destination.

3. The non-transitory computer-readable storage medium according to claim 1, wherein the predetermined setting is a setting related to a predetermined function of the first image processing apparatus.

4. The non-transitory computer-readable storage medium according to claim 2, wherein the connection destination information is a Uniform Resource Locator (URL) corresponding to the setting screen generated by the first image processing apparatus.

5. The non-transitory computer-readable storage medium according to claim 1, wherein the setting values include setting values of a network and setting values related to software installation.

6. The non-transitory computer-readable storage medium according to claim 4, wherein, in the connecting the first image processing apparatus to the information processing apparatus, setting of an IP address of the first image processing apparatus is accepted as a network setting, and the URL includes the IP address which has been set.

7. The non-transitory computer-readable storage medium according to claim 1, wherein, in the displaying of the setting screen, a setting value input field of a setting item that does not correspond to the obtained setting value is displayed as a blank.

8. The non-transitory computer-readable storage medium according to claim 1, wherein in the displaying of the setting screen, the setting screen of the predetermined setting is not displayed in a case where all the setting items of the predetermined setting include a setting item corresponding to the obtained setting value.

9. The non-transitory computer-readable storage medium according to claim 1, wherein the import request is issued by selecting an import button included in the setting screen.

10. An information processing apparatus that can set up a first image processing apparatus in a system including the first image processing apparatus and a second image processing apparatus that can communicate with the information processing apparatus, the information processing apparatus comprising:
one or more controllers including one or more processors and one or more memories, the one or more controllers configured to:
perform network setting to connect the first image processing apparatus to the information processing apparatus via a network;
receive, from the first image processing apparatus, connection destination information for displaying a setting screen that allows for performing predetermined setting of the first image processing apparatus connected via the network;
obtain, based on an import request for setting values which have been set in a second image processing apparatus, the setting values which have been set in the second image processing apparatus;
display a setting screen on which input of setting items corresponding to the obtained setting values has been made unnecessary, when accessing a connection destination indicated by the connection destination information and displaying the setting screen of the first image processing apparatus; and
set up the first image processing apparatus by setting, to the first image processing apparatus, the setting values which have been set via the setting screen.

11. The information processing apparatus according to claim 10, wherein, in the displaying of the setting screen, the one or more controllers is configured to cause a Web browser installed in the information processing apparatus to access the connection destination indicated by the connection destination information, and
wherein the Web browser displays the setting screen based on data obtained from the connection destination.

12. The information processing apparatus according to claim 10, wherein the predetermined setting is a setting related to a predetermined function of the first image processing apparatus.

13. The information processing apparatus according to claim 11, wherein the connection destination information is a URL corresponding to the setting screen generated by the first image processing apparatus.

14. The information processing apparatus according to claim 10, wherein the setting values include setting values of a network and setting values related to software installation.

15. The information processing apparatus according to claim 13, wherein, in the connecting to the first image processing apparatus via the network, setting of an IP address of the first image processing apparatus is accepted as a network setting, and the URL includes the IP address which has been set.

16. The information processing apparatus according to claim 10, wherein, in the displaying of the setting screen, the one or more controllers is configured to display a setting value input field of a setting item that does not correspond to the obtained setting value as a blank.

17. The information processing apparatus according to claim 10, wherein, in the displaying of the setting screen, the one or more controllers is configured to avoid displaying the setting screen of the predetermined setting in a case where all the setting items of the predetermined setting include a setting item corresponding to the obtained setting value.

18. The information processing apparatus according to claim 10, wherein the import request is issued by selecting an import button included in the setting screen.

19. A system comprising a first image processing apparatus and a second image processing apparatus that can communicate with an information processing apparatus, wherein
the information processing apparatus comprises
one or more first controllers including one or more first processors and one or first more memories, the one or more first controllers configured to:
perform network setting to connect the first image processing apparatus to the information processing apparatus via a network;
receive, from the first image processing apparatus, connection destination information for displaying a setting screen that allows for performing predetermined setting of the first image processing apparatus connected via the network;
obtain, based on an import request for setting values which have been set in a second image processing apparatus, the setting values which have been set in the second image processing apparatus;
display a setting screen on which input of setting items corresponding to the obtained setting values has been made unnecessary, when accessing a connection destination indicated by the connection destination information and displaying the setting screen of the first image processing apparatus; and
set up the first image processing apparatus by setting, to the first image processing apparatus, the setting values which have been set via the setting screen,
the first image processing apparatus includes
one or more second controllers including one or more second processors and one or more second memories, the one or more second controllers configured to:
generate a Web page for displaying the setting screen, and transmits a URL of the Web page to the information processing apparatus as the connection destination information, and
the second image processing apparatus includes
one or more third controllers including one or more third processors and one or more third memories, the one or more third controllers configured to:
transmit information of the setting value which has been set in the second image processing apparatus in response to the import request.

20. The system according to claim 19, wherein the first image processing apparatus includes a display unit configured to display a setting screen including settings which have been set by the information processing apparatus, and
the one or more second controllers is configured to: include an object for instructing editing of the settings on the setting screen, and instruct the information processing apparatus to edit the settings in accordance with a designation of the object.
